(19) United States
(12) Patent Application Publication
(10) Pub. No.: US 2009/0147941 A1
(43) Pub. Date: Jun. 11, 2009

(54) Method and system for reducing a perceived call transfer delay between a target and a talker

(76) Inventors: Ilya Abezgauz Druzhnikov, Portola Valley, CA (US); Girts Graudins, Berkeley, CA (US); Bob Cohen, Redwood City, CA (US); Andrei Stoica, Farmington Hills, MI (US)

Correspondence Address: ELLIOT FURMAN, 15 WEST 81ST STREET #11J, NEW YORK, NY, 10024, US

(21) Appl. No.: 12/330,223

(22) Filed: Dec. 8, 2008

Related U.S. Application Data
(60) Provisional application No. 61/012,117, filed on Dec. 7, 2007.
(60) Provisional application No. 61/114,414, filed on Nov. 13, 2008.

(51) Int. Cl. H04M 3/42

(52) U.S. Cl. 379/212.01

(57) ABSTRACT

A method and system reduces a perceived call transfer delay between a target and a talker. The perceived transfer delay is caused by the reaction time of the talker when the call is transferred. The call is transferred from between a caller and the target, to between the talker and target. The method comprises recording a message. The message may be recorded before the start of a call session. The message may be recorded by the talker. Upon the call transfer, the message is played to the target. Also upon the call transfer, lead data of the target is displayed to the talker. When the message is finished playing, the talker is connected to the target such that the talker and the target can speak with each other.

This application claims the benefit of U.S. Provisional Application No. 61/012,117, filed Dec. 7, 2007, and U.S. Provisional Application No. 61/114,414, filed Nov. 13, 2008, both of which are hereby incorporated by reference.

### BACKGROUND

There exist various systems and methods for transferring a call so that a caller can connect a salesperson (also referred to herein as a “talker”) to a decision maker (also referred to herein as a “target”) without the decision maker ever knowing that the caller was involved. The best of these systems and methods transfers the call instantly so that there is no perceived transfer delay, that is, no perceivable time lag, delay, or noise in the transfer; in this way the target is unaware that it was a caller, not the salesperson, who navigated through gatekeepers such as secretaries, voice mail systems, and the like in order to reach him. Additionally, the best of these systems and methods transfers complete call information to the salesperson when the call is transferred. The call information (also referred to herein as “lead data”) is displayed concurrent with the call transfer, for example, on the salesperson's computer.

While the best of these systems and methods do not introduce a perceivable transfer delay when the call is transferred from between the caller and the target, to between the talker and the target, a delay can be induced by the talker due to the reaction time of the talker when the call is transferred. There are a number of human factors that can prolong the reaction time, and thus the perceived transfer delay. For example, humans have a natural limit or lag when reacting to inputs or stimuli. This lag can be as great at two seconds.

Thus, a need presently exists for a system and method for reducing a perceived call transfer delay caused by human factors when the call is transferred from between a caller and the target, to between the talker and the target.

### SUMMARY

A method and system reduces a perceived call transfer delay between a target and a talker. The perceived transfer delay is caused by the reaction time of the talker when the call is transferred. The call is transferred from between a caller and the target, to between the talker and target. The method comprises recording a message. The message may be recorded before the start of a call session. The message may be recorded by the talker. Upon the call transfer, the message is played to the target. Also upon the call transfer, lead data of the target is displayed to the talker. When the message is finished playing, the talker is connected to the target such that the talker and the target can speak with each other.

### BRIEF DESCRIPTION OF THE DRAWINGS

FIG. 1 shows a system for reducing a perceived call transfer delay integrated with a call handling system.

FIG. 2 is a method for reducing a perceived call transfer delay between a target and a talker when the call is transferred from between a caller and the target to between the talker and the target.

### DETAILED DESCRIPTION

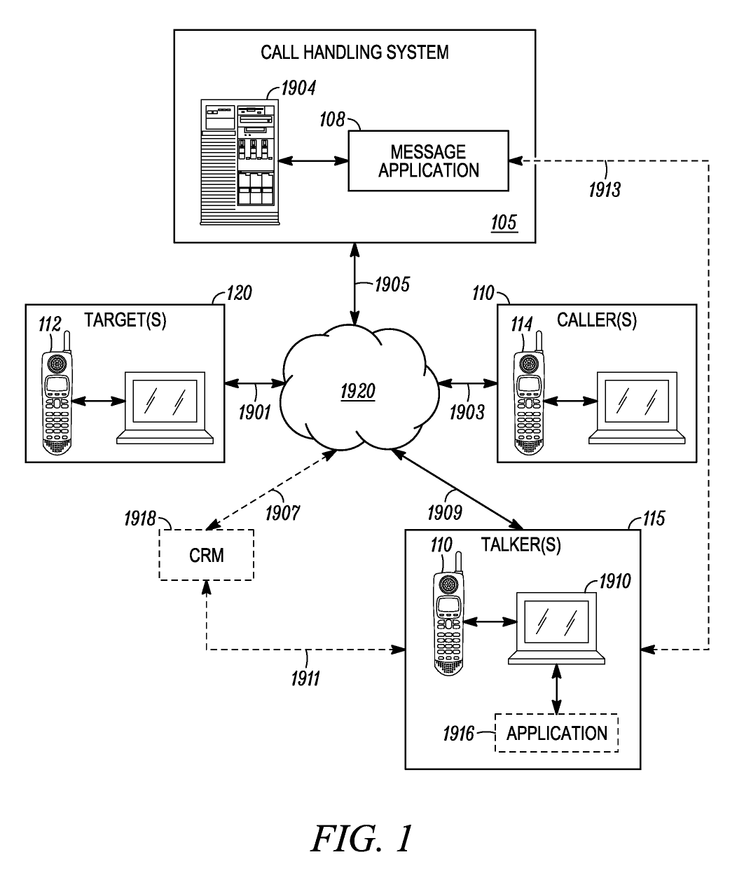

FIG. 1 shows a system for reducing a perceived call transfer delay integrated with a call handling system. The system includes a call handling system 105, a target(s) 120, a caller(s) 110, a talker(s) 115 all in communication via a network 1920. The system may also include a customer relationship management system (CRM) in communication with the network 1920 or the talker 115. The system of FIG. 1 and associated methods are as set forth in U.S. patent application Ser. No. 11/556,301 filed Nov. 3, 2006 and published on May 31, 2007 as U.S. Patent Publication No. US 2007/0121902 A1, and U.S. Provisional Application No. 61/012,117, filed Dec. 7, 2007, and U.S. Provisional Application No. 61/114,414, filed Nov. 13, 2008, all of which are hereby incorporated by reference.

Briefly, the callers 110 request the call handling system 105 to initiate a call with a target 120. A database of targets is maintained by the call handling system, however, it is often the case that the telephone numbers of the targets results in a call to a gatekeeper. The database of targets may additionally or optionally maintained by a customer relationship management system. Once the call is initiated, the callers 110 navigate through phone trees, bad connections, operators, receptionists, voice mail, automated voice responses, and the like (herein referred to as “gatekeepers”) to connect to the target 120. Once the target is located, in response to a call transfer request placed by the caller's computer-based interface, the call handling system 105 switches the call to the talker 115. The call handling system 105 switches the call quickly enough so that the target is completely unaware that it was the caller who navigated the gatekeepers to reach him; that is, the call handling system 105 does not introduce a time lag, delay, or noise that is perceivable to the talker upon transfer. Also, upon transfer, lead data of the target 120 is displayed to the talker 115. Thereafter, the talker speaks with the target to perform a task or meet an objective, for example, sales and marketing of a product, providing technical services, and the like.

While the call handling system does not introduce a perceivable transfer delay, the target 120 may still perceive a transfer delay due to the reaction time of the talker 115 when the call is transferred. There are a number of human factors which potentially prolong the perceived transfer delay. In particular, some talkers have a natural reaction lag of up to two seconds after they become aware of the transfer. Such a lag is significant enough to cause the target to hang up.

In an example, when the call is transferred from between the caller and the target to between the talker and target, the talker typically hears on his telephone or headset 110, the end of the target's greeting. For example, if the target is Joe Smith, the caller would hear the target's greeting, “Hello, this is Joe Sm . . . ”, and transfer the call as quickly as possible. The talker would thus hear “ . . . ith,” at which time the talker must immediately begins his pitch. Lead information about the target is displayed concurrent with transfer. While the talker has all of the information necessary to make a sales pitch, his natural reaction time may introduce a perceived transfer delay. Also, the talker may be reviewing the lead data when the target finishes his greeting, thus adding time to the perceived delay.

To reduce the perceived transfer delay induced by the talker, and to give the talker more time to review the lead data, a message application module 108 integrated with the call handling system is in communication with the computer 1910 of the talker.

Briefly, the message application module 108 communicates with the talker's computer 1910 to allow the talker to record a greeting message via his phone or headset 110. The message application module is in communication with one or more modules of the call handling system such as, for example, an administrator module, a talker module, a caller module, an exchange module, and a database. The call handling system, upon transfer, plays the greeting message to the target, thus giving the talker additional time to react to the transfer. Connection 1913 represents a direct or indirect connection between the talker 115 and the call handling system 105. For example, connection 1913 may typically be a connection established through network 1920, like the internet, via connections 1909 and 1905. The Connection 1913 may be a connection via a Local Area Network (LAN) or a Wide Area Network (WAN).

The message may be stored by the application 1916 local to the talker's computer, or may be stored by the message application module 108 of the call handling system 105, or both. The call handling system may store the message, and the message may be automatically downloaded to the talker's computer 1910 when the talker logs on to the call handling system or initiates a calling session.

In one implementation, the talker's interface displayed on computer 1910 allows the talker to pre-record a brief greeting. Application 1916 may facilitate this. The greeting is a message that is automatically played to the target as soon as the call has been transferred, eliminating some of the time lag. In one example, instead of playing a beep to the talker to alert the talker that a transfer has occurred, the system plays the greeting message to the talker. The talker hears the message playback which notifies him that a transfer has occurred. While the message continues, the talker has an extended period of time to view the target's lead data on the computer 1910 and prepare for the conversation.

In order for the message to be effective, it may be recorded before the calling session begins. This helps reduce the possibility that there is any difference in the target's voice (such as hoarseness) between the recording and the time of calling session and transfer. This further eliminates the possibility that the target will be aware of the call transfer and that he is hearing a recorded greeting rather than a live voice.

In one implementation, the talker's interface includes a record button that looks like a microphone. When the record button is held down, the talker's message is recorded. When the button is released, the recording is stopped. The length of the recording may be displayed. It is appreciated that there are many ways to start and stop the recording process via a button, or via some other means, and that recording and playback of messages on a computer is well understood by those having ordinary skill in the art.

The message is recorded by speaking into the same telephone 110 that the talker uses to talk to his targets. This causes the recording to sound exactly as the talker sounds on that phone during the session. The talker may make a new recording for each session to help ensure that the message has the same qualities of the talker's voice as it will be for the session, not the qualities of a past session during which voice tone, timbre, and other qualities may be noticeably different.

Once a recording has been made the taker may listen to it by clicking on the speaker button, or equivalent, located just below the microphone button, or equivalent, in the talker's interface. If the talker does not like the message he can re-record. A new message erases a previous one. In another embodiment, more than one message may be recorded and chosen by the talker depending on the target's lead data.

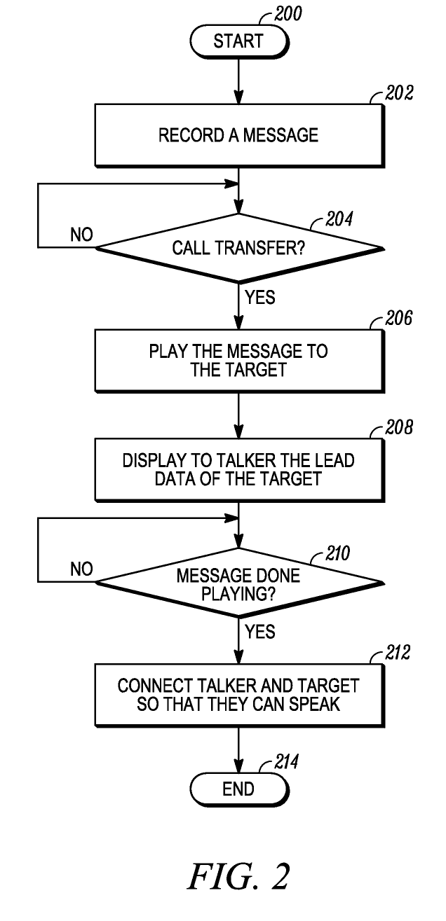

With the above disclosure in mind, including all equivalents, FIG. 2 is a method for reducing a perceived call transfer delay between a target and a talker when the call is transferred from between a caller and the target to between the talker and the target.

The method starts at step 200, and at step 202 a message is recorded. For reasons discussed above, the message is typically recorded before the start of a call sessions. The message may be played back to the talker and the message may be re-recorded if desired. More than one message may be recorded and later selected or chosen based on the target's lead data. If a plurality of messages are recorded, each message may be associated with one or more leads in the lead database.

At step 204, the method is paused if a call transfer has not occurred. If a call transfer has occurred the method continues to step 206. The call transfer transfers the call from between the caller and the target to between the talker and the target.

At step 206 the message is played to the target. In one embodiment, before playing the message, it is determined if the talker is speaking. If the target is speaking, the message is not played until it is detected that target has stopped speaking. This eliminates the possibility where the target is speaking his greeting while simultaneously the talker is speaking his greeting via the recorded message. Such crosstalk could alert the target that he is not speaking with a live person.

At step 208 the lead data of the target is displayed to the talker.

While the message is playing to the target, the talker is connected to the target such that the talker can hear the target and the target cannot hear the talker. This allows the talker to hear the message and thus know when the message has ended. This also eliminates the possibility of the target hearing any noise or other sounds picked up the talker's telephone during message playback.

Additionally, if the talker recorded a plurality of messages, the message selected to be played at step 206 is chosen depending on the lead data of the target. For example, the talker may pre-select the message to be played depending on who the target might be. In another example, the message is automatically chosen from the plurality of the message depending on details of the lead data. For example, if there are five potential targets at five different companies, the talker may record five different messages, each one linked in a database to lead data for each target. Upon call transfer, the message linked with the lead data of the target (that is, the target of step 208), is played (step 206).

At step 210 the method is paused until the message has completed playing. When the message has completed playing, at step 212 the talker and the target are connected such that they can speak with each other. Specifically, at step 212 the talker can hear the target and the target can hear the talker; the talker can speak with target and the target can speak with the talker; the transfer is complete (step 214) and a normal telephone connection and conversation ensues.

The foregoing detailed description has discussed only a few of the many forms that this invention can take. It is intended that the foregoing detailed description be understood as an illustration of selected forms that the invention can take and not as a definition of the invention. It is only the following claims, including all equivalents, that are intended to define the scope of this invention.

What is claimed is:

1. A method for reducing a perceived call transfer delay between a target and a talker, the perceived transfer delay caused by the reaction time of the talker when the call is transferred from between a caller and the target to between the talker and the target, the method comprising:
recording a message;
upon the call transfer which transfers the call from between the caller and the target to between the talker and the target, playing the message to the target;
upon the call transfer, displaying lead data of the target to the talker; and
when the message is finished playing, connecting the talker to the target such that the talker and the target can speak with each other.

2. The method of claim 1 further comprising while the message is playing to the target, connecting the talker to the target such that the talker can hear the target and the target cannot hear the talker.

3. The method of claim 1 further comprising, during the step of playing, connecting the talker to the target such that the talker can hear the target.

4. The method of claim 1 further comprising, during the step of playing, connecting the talker to the target such that the target cannot hear the talker.

5. The method of claim 1 wherein the step of recording comprises recording the message before the start of a call session.

6. The method of claim 1 wherein the step of recording comprises the talker recording the message.

7. The method of claim 6 further comprising playing back the message to the talker.

8. The method of claim 6 further comprising the talker re-recording the message.

9. The method of claim 1 further comprising, after the call transfer but before playing the message:
detecting if the talker is speaking; and
if the talker is speaking, playing the message only after the talker has stopped speaking.

10. The method of claim 1 further comprising recording at least one additional message such that there are a plurality of messages, and wherein the step of playing the message includes choosing one message of the plurality of messages depending on the lead data of the target.

11. A system for reducing a perceived call transfer delay between a target and a talker, the perceived transfer delay caused by the reaction time of the talker when the call is transferred from between a caller and the target to between the talker and the target comprising:
means for recording a message;
means for playing the message to the target upon the call transfer which transfers the call from between the caller and the target to between the talker and the target;
means for displaying lead data of the target to the talker upon the call transfer; and
means for connecting the talker to the target such that the talker and the target can speak with each other when the message is finished playing.

12. The system of claim 11 further comprising detecting means for detecting if the talker is speaking after the call transfer but before playing the message, and if the talker is speaking, playing the message only after the talker has stopped speaking.

13. The system of claim 11 further comprising means for playing the message depending on the lead data of the target.

14. A system connecting callers, targets, and talkers comprising:
a network;
a target in communication with the network;
a talker in communication with the network;
a caller in communication with the network; and
a call handling system means for transferring a call from between the caller and the target, to between the talker and the target, and upon the transfer play a message recorded by the talker and display lead data of the target to the talker and, after the message is finished playing, connect the talker and the target such that they can speak with each other.

15. The system of claim 14 further comprising a customer relationship management system in communication with the network.
